(19) United States
(12) Patent Application Publication
(10) Pub. No.: US 2026/0160593 A1
(43) Pub. Date: Jun. 11, 2026

(54) LIGHT GUIDE STRUCTURE AND ELECTRONIC DEVICE USING THE SAME

(71) Applicant: Qisda Corporation, Taoyuan City (TW)

(72) Inventors: Yung-Chun SU, Taoyuan City (TW); Yu-Liang CHENG, Taoyuan City (TW)

(73) Assignee: Qisda Corporation, Taoyuan City (TW)

(21) Appl. No.: 19/300,800

(22) Filed: Aug. 15, 2025

(30) Foreign Application Priority Data
Dec. 10, 2024 (CN) 202411813756.8

(51) Int. Cl. G01J 1/04; G01J 1/06; G01J 1/42; G02B 6/32

(52) U.S. Cl. CPC G01J 1/0411; G01J 1/06; G01J 1/4204; G02B 6/32

(57) ABSTRACT

The present invention provides a light guide structure for a light sensor. The light sensor is used to sense ambient light incident on an opening of a decorative plate of an electronic device. The light guide structure includes a light guide plate. The light guide plate has an outer surface and an inner surface, and a part of the light guide plate protrudes from the outer surface toward the opening to form a light guide portion. The light guide portion has a light incident surface and a light emitting surface. The light incident surface is located outside the opening, and the light emitting surface is arranged opposite to the light sensor.

This application claims the benefit of People's Republic of China application Serial No. 202411813756.8, filed Dec. 10, 2024, the subject matter of which is incorporated herein by reference.

### BACKGROUND OF THE INVENTION

### Field of the Invention

The invention relates in general to a light guide structure, and more particularly to a light guide structure for a light sensor.

### Description of the Related Art

Currently, electronic devices such as displays are usually provided with an ambient light sensor to adjust the brightness of the screen according to the intensity of the surrounding light. Existing ambient light sensors are generally located above or below the screen frame of an electronic device. However, due to the changes in light intensity caused by differences in incident angles, the screen brightness will change accordingly, thereby affecting the user's experience.

In order to allow light to reach the ambient light sensor evenly, the field-of-view (FoV) of the ambient light sensor must be adjusted. The larger the field of view, the more sensitive the ambient light sensing is. However, due to the shape and structural design of the screen frame, the viewing angle usually cannot reach the expected angle, so that the brightness of the display screen changes and affects the user's experience.

Therefore, it is necessary to design a new light guide structure to overcome the above defects.

### SUMMARY OF THE INVENTION

The invention relates to a light guide structure used in an electronic device with an ambient light detection function, which can increase the light intensity of the incident ambient light and increase the field of view of the light sensor, thereby avoiding changes in light sensing intensity caused by differences in incident angles.

To achieve the above objectives, the present invention provides a light guide structure for a light sensor, wherein the light sensor is used to sense ambient light incident on an opening of a decorative plate of an electronic device. The light guide structure includes a light guide plate. The light guide plate has an outer surface and an inner surface, and a part of the light guide plate protrudes from the outer surface toward the opening to form a light guide portion. The light guide portion has a light incident surface and a light emitting surface. The light incident surface is located outside the opening, and the light emitting surface is arranged opposite to the light sensor.

The light guide structure for the optical sensor provided in the present invention has a light guide portion, which protrudes from the outer surface of the light guide plate toward the opening of the decorative plate so that its light incident surface is exposed on the outside of the decorative plate. Therefore, ambient light at a large angle can be incident on the light incident surface of the light guide portion and output to the optical sensor through the light emitting surface of the light guide portion, thereby increasing the light intensity of the incident ambient light and increasing the field of view angle of the optical sensor, thereby avoiding changes in light sensing intensity caused by differences in incident angles, thereby improving the user's experience.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic three-dimensional diagram of a light guide structure for an electronic device with an ambient light detection function according to a first embodiment of the present invention.

FIG. 2 is a schematic three-dimensional diagram of a light guide structure according to a first embodiment of the present invention.

FIG. 3 is a schematic cross-sectional view of the light guide structure in FIG. 2 along line segment A-A′.

FIG. 4 is a schematic diagram illustrating the large-angle ambient light incident on the light incident surface of the light guide structure in FIG. 3.

FIGS. 5A to 5C are schematic diagrams of microstructures according to different embodiments of the present invention.

FIG. 6 is a schematic three-dimensional diagram of a light guide structure according to a second embodiment of the present invention.

FIG. 7 is a schematic cross-sectional view of a light guide structure in FIG. 6 along line segment B-B′.

FIGS. 8A and 8B are schematic diagrams showing the appearance of the light guide plate and the light shielding member in FIG. 7, respectively.

### DETAILED DESCRIPTION OF THE INVENTION

In order to provide a further understanding of the purpose, structure, features, and functions of the present invention, the following detailed description is given in conjunction with the embodiments.

Certain terms are used throughout the description and claims to refer to particular elements. It should be understood by those skilled in the art that manufacturers may use different names to refer to the same element. This specification and claims do not use differences in names as a means of distinguishing elements, but rather use differences in functions of elements as a criterion for distinction. The term “comprising” mentioned throughout the specification and claims is an open-ended term and should be interpreted as “including but not limited to”.

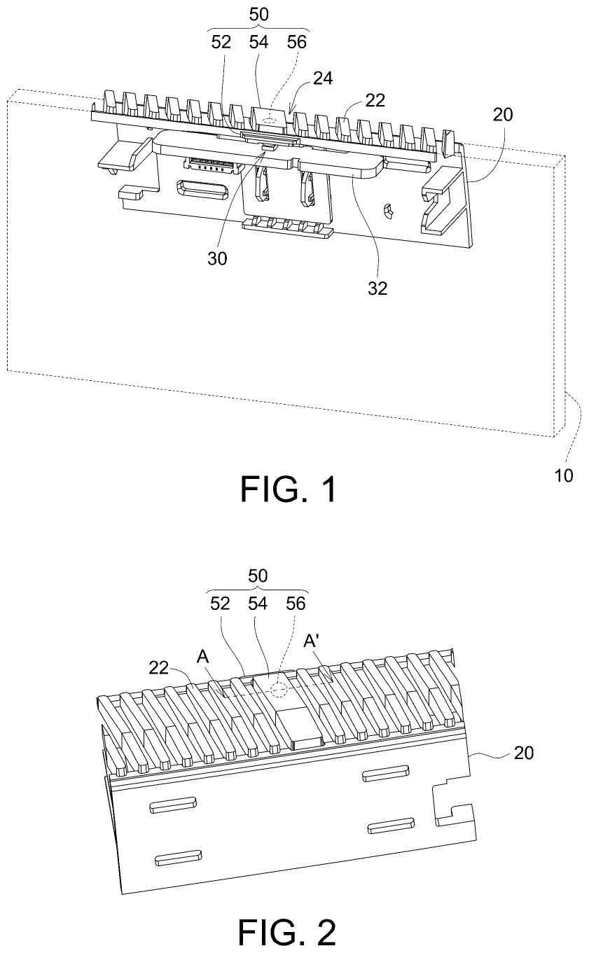

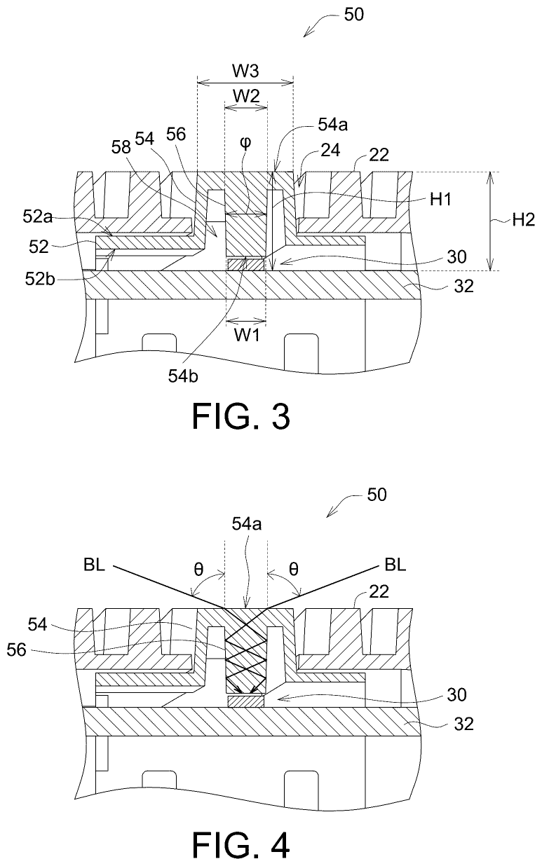

Referring to FIGS. 1 to 4, FIG. 1 is a three-dimensional schematic diagram of a light guide structure 50 for an electronic device 10 with an ambient light detection function according to a first embodiment of the present invention, FIG. 2 is a three-dimensional schematic diagram of the light guide structure 50 according to the first embodiment of the present invention, FIG. 3 is a cross-sectional view of the light guide structure 50 along the line segment A-A′ in FIG. 2, and FIG. 4 is a schematic diagram of the large-angle ambient light BL in FIG. 3 incident on the light incident surface 54a of the light guide structure 50.

In FIG. 1, the light guide structure 50 is disposed in an electronic device 10 (indicated by dotted lines), such as a display or other electronic devices with a screen display function. The electronic device 10 includes a decorative plate 20, a light sensor 30 and a circuit board 32. The optical sensor 30 is disposed on the circuit board 32. The decorative plate 20 is, for example, located at the outer frame or middle frame of the screen of the electronic device 10 (e.g., a display), and the decorative plate 20 has a plurality of protrusions 22 and an opening 24 (see FIG. 3). The openings 24 are located between the protrusions 22, and the number of the openings 24 is not limited.

In one embodiment, the decorative plate 20 is, for example, a heat sink covering the heat dissipation holes, and the protrusions 22 located above the decorative plate 20 are shaped as long strips of fins. The protrusions 22 are arranged above the decorative plate 20 and have the same shape or height as the screen frame or middle frame of the electronic device 10 to ensure a consistent appearance.

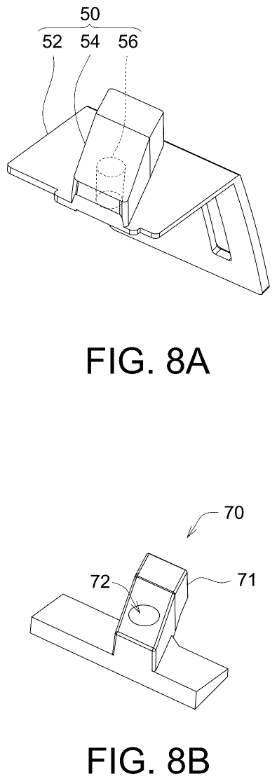

In one embodiment, the shape of the light guide portion 54 (see FIG. 2) of the light guide structure 50 is substantially the same as that of the protrusions 22, for example, both are long strips, and the height of the light guide portion 54 is substantially equal to that of the protrusions 22. As shown in FIGS. 1 and 2, the light guide structure 50 includes a light guide plate 52, and its appearance is shown in FIG. 8A. The light guide plate 52 is arranged on the inner side of the decorative plate 20, and a portion of the light guide plate 52 (i.e., the light guide portion 54) protrudes from the opening 24, so that a portion of the light guide plate 52 (i.e., the light guide portion 54) is exposed on the outside of the decorative plate 20.

Referring to FIG. 3, in one embodiment, the light guide plate 52 has an outer surface 52a and an inner surface 52b, and the light guide portion 54 protrudes from the outer surface 52a of the light guide plate 52 toward the opening 24 and presents a column structure. Therefore, the ambient light BL (see FIG. 4) may be incident into the light guide portion 54 through the outer side of the light guide portion 54. In one embodiment, the light guide plate 52 is made of, for example, polycarbonate (PC) or polymethyl methacrylate (PMMA), which has the characteristics of high clarity, high light transmittance, and easy processing. In one embodiment, the light guide plate 52 may be thermoformed under certain heating conditions to form a light guide portion 54 of a predetermined shape.

Referring to FIG. 3, the light guide portion 54 has a light incident surface 54a and a light emitting surface 54b. The light incident surface 54a is located outside the opening 24 to receive incident ambient light BL. The light emitting surface 54b is disposed opposite to the light sensor 30, and the incident ambient light BL can be output to the light sensor 30 through the light emitting surface 54b. In one embodiment, the light sensor 30 is located below the light guide portion 54, and the incident ambient light BL can move downward through total reflection of the light guide column 56 until the incident ambient light BL is emitted through the light emitting surface 54b.

Referring to FIG. 3, the light guide column 56 is located above the optical sensor 30, and the light guide column 56 has an outer diameter φ, which is less than a width dimension W3 of the light incident surface 54a in the radial direction. For example, the light guide column 56 is substantially a flat-top conical column, one end surface of the light guide column 56 close to the light sensor 30 has a first radial dimension W1, and the other end surface away from the light sensor 30 has a second radial dimension W2, and the first dimension W1 is smaller than the second dimension W2. In one embodiment, the ratio of the second dimension W2 to the first dimension W1 is approximately between 1.05 and 1.5, or between 1.2 and 1.3. In addition, the radial width W3 of the light incident surface 54a is enlarged, for example, greater than the radial width of the protrusions 22 of the decorative plate 20, so as to increase the incident light amount of the ambient light BL. For example, the ratio of the width dimension W3 of the light incident surface 54a in the radial direction to the second dimension W2 is approximately between 1.8 and 2.5, or between 2.0 and 2.2.

In addition, in one embodiment, the height of the light guide portion 54 is substantially equal to the height of the protrusions 22. For example, the height H1 of the light guide portion minus the height H2 of the protrusion divided by the height H1 of the light guide portion 54 is within approximately 5%, that is, (H1−H2)/H1 is less than or equal to 5%.

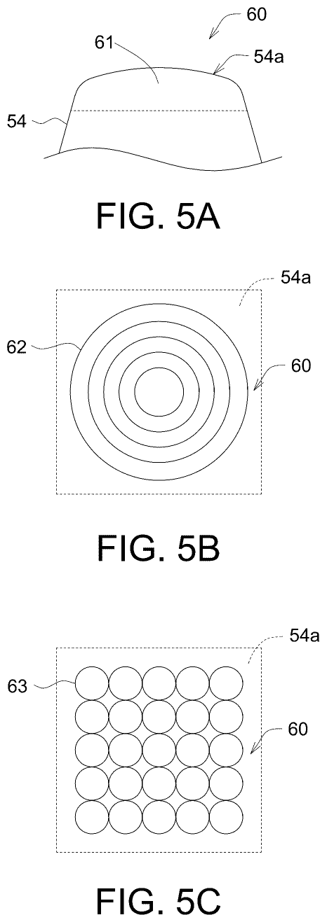

Referring to FIGS. 3 and 4, the light guide portion 54 has a groove 58, and the groove 58 is formed by being recessed from the inner surface 52b toward the light incident surface 54a. The light guide column 56 is located in the groove 58 and is formed by extending from the inner surface 52b of the light guide plate 52 toward the light emitting surface 54b, so that the incident ambient light BL can be transmitted to the light emitting surface 54b through the light guide column 56. In one embodiment, the light guide plate 52 can increase the light flux of the incident ambient light BL by means of the light guide column 56 disposed in the groove 58. In addition, the light guide plate 52 can also increase the viewing angle of the light sensor 30 by means of the microstructures 60 (see FIGS. 5A to 5C) disposed on the light incident surface 54a of the light guide portion 54.

In FIG. 4, ambient light BL incident at a large angle, such as an incident angle θ greater than or equal to 45 degrees or greater than or equal to 60 degrees, can be refracted by any of the microstructures 60 (see FIGS. 5A to 5C) and incident into the light guide column 56 below the light incident surface 54a. That is, the maximum incident angle θ of the ambient light BL relative to the normal line of the light sensor 30 may be greater than or equal to 45 degrees. Therefore, the light intensity of the incident ambient light BL can be increased and the field-of-view (FoV) of the light sensor 30 can be increased to avoid the changes in light sensing intensity caused by the incident angle difference. In this way, the light intensities measured by the light sensors 30 installed in different electronic devices 10 (e.g., displays) under the same ambient light BL can remain consistent, thereby improving the user's experience. For example, when a user uses two electronic devices 100 (e.g., displays) located at different positions as a common display screen, the intensity of the ambient light BL detected by the light sensors 30 installed in different electronic devices 10 (e.g., displays) must be consistent or similar, so that the brightness of the common display screen will not differ too much and affect the user's experience.

Referring to FIG. 5A to FIG. 5C, schematic diagrams of microstructures 60 according to different embodiments of the present invention are illustrated. In FIG. 5A, the microstructure 60 is, for example, an aspheric convex lens 61 disposed on the light incident surface 54a of the light guide portion 54. The aspheric convex lens 61 protrudes from the light incident surface 54a of the light guide portion 54 to achieve a focusing effect. In FIG. 5B, the microstructure 60 is, for example, a Fresnel lens 62 disposed on the light incident surface 54a of the light guide portion 54. The Fresnel lens 62 is a lens composed of a plurality of concentric circular or trapezoidal grooves, which is thinner and lighter than a traditional convex lens, and can refract more light into the light guide portion 54. In FIG. 5C, the microstructure 60 is, for example, an array lens 63 disposed on the light incident surface 54a of the light guide portion 54. The array lens 63 is composed of a plurality of tiny sub-lenses forming an array on a plane, and can have a similar optical effect to a convex lens.

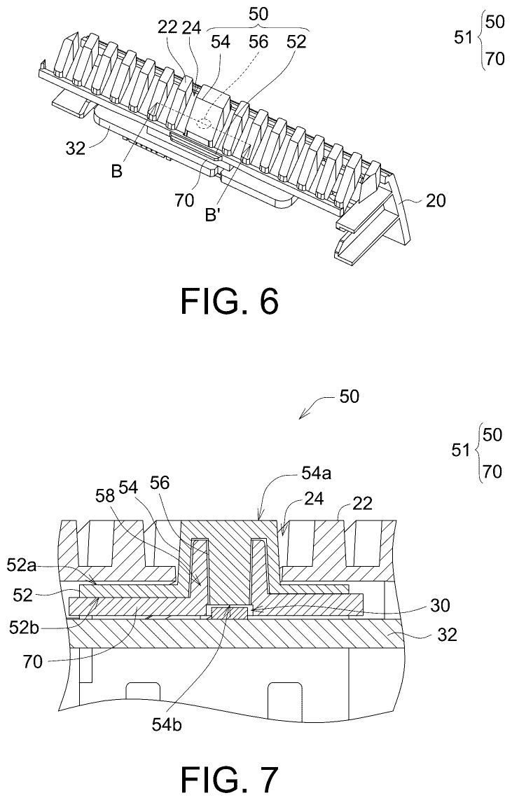

Referring to FIGS. 6 to 8B, FIG. 6 is a three-dimensional schematic diagram of the light guide structure 51 according to a second embodiment of the present invention, FIG. 7 is a cross-sectional schematic diagram of the light guide structure 51 in FIG. 6 along the line segment B-B′, and FIGS. 8A and 8B are schematic diagrams of the appearance of the light guide plate 52 and the light shielding member 70 in FIG. 7, respectively.

FIGS. 6 and 7, the second embodiment is different from the first embodiment in that the light guide structure 51 includes a light guide plate 52 and a light shielding member 70. The light guide plate 52 is disposed inside the decorative plate 20, and a portion of the light guide plate 52 (i.e., the light guide portion 54) protrudes from the opening 24 so as to be exposed outside the decorative plate 20. In addition, the light shielding member 70 is disposed on a side of the light guide plate 52 opposite to the inner surface 52b. The light shielding member 70 can provide a light filtering effect to avoid interference from stray light.

In one embodiment, the light shielding member 70 is accommodated in the groove 58, and the light shielding member 70 covers the periphery of the light guide column 56. As shown in FIG. 8B, the light shielding member 70 has a cylindrical hollow portion 72, and the outer diameter and shape of the cylindrical hollow portion 72 match the outer diameter and shape of the light guide column 56, so that the light guide column 56 can be accommodated in the cylindrical hollow portion 72. In addition, the light shielding member 70 may be a dark body 71 including light-blocking particles or paint. In one embodiment, the shielding member 70 may be thermoformed under certain heating conditions to form the light shielding member 70 in a predetermined shape. In addition, the shape of the dark body 71 of the light shielding member 70 is substantially the same as the shape of the groove 58 of the light guide portion 54, such as a long-strip shape, so that the light shielding member 70 can be accommodated in the groove 58.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light guide structure for a light sensor, the light sensor being used to sense ambient light incident on an opening of a decorative plate of an electronic device, the light guide structure comprising:
a light guide plate having an outer surface and an inner surface, wherein a portion of the light guide plate protrudes from the outer surface toward the opening to form a light guide portion;
wherein the light guide portion has a light incident surface and a light emitting surface, the light incident surface is located outside the opening, the light emitting surface is arranged opposite to the light sensor.

2. The light guide structure as claimed in claim 1, further comprising a light shielding member disposed on a side of the light guide plate corresponding to the inner surface, the light shielding member covering a periphery of the light sensor.

3. The light guide structure as claimed in claim 1, wherein the light guide portion comprises a microstructure, the microstructure is located on the light incident surface.

4. The light guide structure as claimed in claim 3, wherein the microstructure comprises at least one of a convex lens, a Fresnel lens and a lens array.

5. The light guide structure as claimed in claim 2, wherein a portion of the light guide portion extends from the inner surface of the light guide plate toward the light emitting surface to form a light guide column, the light guide column is correspondingly located above the light sensor.

6. The light guide structure as claimed in claim 5, wherein the light guide column has an outer diameter, the outer diameter is less than a width dimension of the light incident surface in a radial direction.

7. The light guide structure as claimed in claim 5, wherein a portion of the inner surface of the light guide plate is recessed toward the light incident surface to form a groove, the light guide column is located in the groove.

8. The light guide structure as claimed in claim 7, wherein the light shielding member is accommodated in the groove, the light shielding member covers the periphery of the light guide column.

9. The light guide structure as claimed in claim 1, wherein the opening is located between a plurality of protrusions of the decorative plate, an appearance of the light guide portion matches an appearance of the plurality of protrusions, a height of the light guide portion is substantially equal to a height of one of the plurality of protrusions.

10. The light guide structure as claimed in claim 9, wherein the light sensor is used to receive the ambient light incident through the light guide portion, a maximum incident angle of the ambient light relative to a normal line of the light sensor is greater than or equal to 45 degrees.

11. An electronic device with an ambient light detection function, the electronic device comprising:
a light sensor for sensing ambient light incident on an opening of a decorative plate of an electronic device; and
a light guide structure comprising:
a light guide plate having an outer surface and an inner surface, wherein a portion of the light guide plate protrudes from the outer surface toward the opening to form a light guide portion;
wherein the light guide portion has a light incident surface and a light emitting surface, the light incident surface is located outside the opening, the light emitting surface is arranged opposite to the light sensor.

12. The electronic device as claimed in claim 11, further comprising a light shielding member disposed on a side of the light guide plate corresponding to the inner surface, the light shielding member covering a periphery of the light sensor.

13. The electronic device as claimed in claim 11, wherein the light guide portion comprises a microstructure, the microstructure is located on the light incident surface.

14. The electronic device as claimed in claim 13, wherein the microstructure includes at least one of a convex lens, a Fresnel lens and a lens array.

15. The electronic device as claimed in claim 12, wherein a portion of the light guide portion extends from the inner surface of the light guide plate toward the light emitting surface to form a light guide column, the light guide column is correspondingly located above the light sensor.

16. The electronic device as claimed in claim 15, wherein the light guide column has an outer diameter, the outer diameter is less than a width dimension of the light incident surface in a radial direction.

17. The electronic device as claimed in claim 15, wherein a portion of the inner surface of the light guide plate is recessed toward the light incident surface to form a groove, the light guide column is located in the groove.

18. The electronic device as claimed in claim 17, wherein the light shielding member is accommodated in the groove, the light shielding member covers a periphery of the light guide column.

19. The electronic device as claimed in claim 11, wherein the opening is located between a plurality of protrusions of the decorative plate, and a shape of the light guide portion matches a shape of the plurality of protrusions, a height of the light guide portion is substantially equal to a height of one of the plurality of protrusions.

20. The electronic device as claimed in claim 19, wherein the light sensor is used to receive the ambient light incident through the light guide portion, a maximum incident angle of the ambient light relative to a normal line of the light sensor is greater than or equal to 45 degrees.
